(19) United States
(12) Patent Application Publication
(10) Pub. No.: US 2003/0158944 A1
(43) Pub. Date: Aug. 21, 2003

(54) Software control in a business transaction environment

(75) Inventors: Michael John Branson, Rochester, MN (US); Melissa Sue Fichtinger, Rochester, MN (US); Leah Elizabeth Hause, Plainview, MN (US); Gregory Richard Hintermeister, Rochester, MN (US); Erik Duane Lindberg, Pine Island, MN (US); Diane Elaine Olson, Rochester, MN (US); Neela Sharad Patel, Rochester, MN (US); DeVaughn Lawrence Rackham, Rochester, MN (US); Brent Gorden Tang, Rochester, MN (US)

Correspondence Address: Gero G. McClellan, Moser, Patterson & Sheridan, L.L.P., Suite 1500, 3040 Post Oak Boulevard, Houston, TX, 77056-6582, US

(73) Assignee: International Business Machines Corporation, Armonk, NY

(21) Appl. No.: 10/078,605

(22) Filed: Feb. 19, 2002

(51) Int. Cl. G06F 15/16; G06F 17/60

(52) U.S. Cl. 709/227; 705/1

(57) ABSTRACT

The present invention generally is a method of managing the process of a plurality of transactions through two or more applications in a business transaction environment. Each application has at least one associated log file. Each transaction is defined by one or more steps configured to complete the transaction. In one embodiment, for each new log entry recorded in the at least one associated log file, the method determines whether the new log entry comprises one or more required fields, e.g., a transaction identifier, a step identifier, or a time stamp. A set of information is extracted from the new log entry only if the new log entry comprises the one or more required fields. A database comprising a plurality of transaction records from the information is then created. The method then determines whether the plurality of transaction records meets a condition. An action is then executed if the plurality of transactions meets the condition. In one embodiment, the condition is the active transaction that is taking the longest time to complete.

### BACKGROUND OF THE INVENTION

1. Field of the Invention

The present invention generally relates to software control in a business to business environment.

2. Description of the Related Art

Wide area networks such as the Internet provide a convenient forum for engaging in a variety of commercial activities, generally referred to as eCommerce. A typical eCommerce environment includes buyers and sellers connected by the Internet. A typical business-to-business (“B2B”) enterprise consists of multiple software applications operating on multiple computer systems. A transaction, e.g., a purchase order, is generally generated at one computer, e.g., a buyer's computer system, and is then transferred to another computer, e.g., a seller's computer system. The transaction is generally processed from beginning to end without any human intervention to ensure that the transaction is properly processed. That is, no one manages the processing of the transaction in its entirety. As a result, many of these transactions are susceptible to improper or incomplete processing caused by many factors, such as, a formatting mismatch between one application in one computer and another application in another computer. Other causes of improper or incomplete processing may include the inoperation of one of the computer system in the enterprise (e.g., the seller's computer is down) while the transaction is being processed, a software bug in one of the computer systems, and the lack of storage in one of the computer's hard drive. Because each application may have a different way of logging errors or providing status to an operator, it is often necessary for the operator to trace down each computer system on which the application operates in order to determine the status of the transaction or the error that caused the improper or incomplete processing. As one can imagine, this can be a tedious and laborious task, considering that a B2B enterprise generally consists of multiple applications operating multiple computer systems.

A need therefore exists for methods and apparatus that programmatically manage the process of network business transactions.

### SUMMARY OF THE INVENTION

The present invention generally provides a method of managing the process of a plurality of transactions through two or more applications in a business transaction environment. Each application has at least one associated log file. Each transaction is defined by one or more steps configured to complete the transaction. In one embodiment, for each new log entry recorded in the at least one associated log file, the method determines whether the new log entry comprises one or more required fields, e.g., a transaction identifier, a step identifier, or a time stamp. A set of information is extracted from the new log entry only if the new log entry comprises the one or more required fields. A database comprising a plurality of transaction records from the information is then created. The method then determines whether the plurality of transaction records meets a condition. An action is then executed if the plurality of transactions meets the condition. In one embodiment, the condition is the active transaction that is taking the longest time to complete.

Another embodiment of the present invention is directed to a method of creating a database for managing the process of a plurality of transactions through two or more applications in a business transaction environment. Each application has at least one associated log file. Each transaction is defined by one or more steps configured to complete the transaction. In one embodiment, for each new log entry recorded in the at least one associated log file, the method determines whether the new log entry comprises one or more required fields, e.g., a transaction identifier, a step identifier, and a time stamp. A set of information is extracted from the new log entry only if the new log entry comprises the one or more required fields. The information is then stored to a database as a transaction record or a step record. In one embodiment, each transaction record is defined by one or more step records.

Yet another embodiment is directed to a computer-readable medium containing a program which, when executed by a processor, performs an operation of managing the process of a plurality of transactions two or more applications in a business transaction environment. Each application has at least one associated log file. Each transaction is defined by one or more steps configured to complete the transaction. For each new log entry recorded in the at least one associated log file, the operation comprising the steps of: determining whether the new log entry comprises one of more required fields; extracting information from the new log entry only if the new log entry comprises the one of more required fields; and creating a database comprising a plurality of transaction records from the information.

Still another embodiment is directed to a computer comprising: a transaction management program managing the process of a plurality of transactions through two or more applications in a business transaction environment. Each application has at least one associated log file, and each transaction is defined by one or more steps configured to complete the transaction. For each new log entry recorded in the at least one associated log file, the transaction management program, when executed, performs an operation comprising the steps of: determining whether the new log entry comprises one of more required fields; extracting information from the new log entry only if the new log entry comprises the one of more required fields; and creating a database comprising a plurality of transaction records from the information.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrative of a business transaction environment in accordance with an embodiment of the present invention;

FIG. 2 is a flowchart illustrative of a process of creating a database for managing a plurality of transactions in a business transaction environment in accordance with an embodiment of the present invention;

FIG. 3A is an example of the various information extracted from log files in accordance with an embodiment of the present invention;

FIG. 3B is an example of how the extracted information is stored as transaction records and step records in accordance with an embodiment of the present invention;

FIG. 4 is a flowchart illustrative of a process of managing a transaction in a business transaction environment in accordance with an embodiment of the present invention; and

FIG. 5 illustrates an example of a graphical display of the information stored in a database in accordance with an embodiment of the present invention.

### DETAILED DESCRIPTION OF THE PREFERRED EMBODIMENTS

The present invention relates to a method of managing transactions processed through a plurality of computers communicably linked in a business transaction environment, such as business to business, business to client or business to government. The method utilizes the log files that reside with each computer, and more particularly, the log entries recorded in those files. Many of these log files, however, have different formats. The present invention, therefore, extracts the pertinent information associated with each transaction and stores the information into a database. The information is stored in a standard format regardless of the log files from which the information comes. In one embodiment, the information is stored either as a field in a transaction record or step record. Each transaction record is defined by at least one or more step records. The fields that identify or characterize a transaction record include a transaction identifier, a transaction type, a transaction origin, a transaction destination and a transaction status. The fields that identify a step record include a step type, a step location, a step identifier, a step start time and a step end time.

In one embodiment, prior to extracting information associated with each transaction and storing the information into a database, the method first determines whether a new log entry has been recorded in one of the log files in the business to business environment. If so, the method determines whether the new log entry comprises a transaction identifier, a step identifier and a time stamp. If the new log entry contains a transaction identifier, a step identifier and a time stamp, then the pertinent information is extracted from the new log entry.

Once a sufficient number of transactions have been recorded in the database, the database can be used to monitor active transactions, i.e., those that are being processed in the business to business environment. In one embodiment, a determination is made as to whether the plurality of transaction records meets a certain condition. If the condition is met, then a particular action is executed to resolve that condition. For example, one condition may be the number of active transactions that are exceeding a numerical limit. Another condition may be determining the active transaction with the longest duration, i.e., the one that is taking the longest time to complete. The particular actions may include sending a notification message to a system administrator to alert him of the condition or executing a program for resolving the condition, e.g., redistributing the resources processing the transactions.

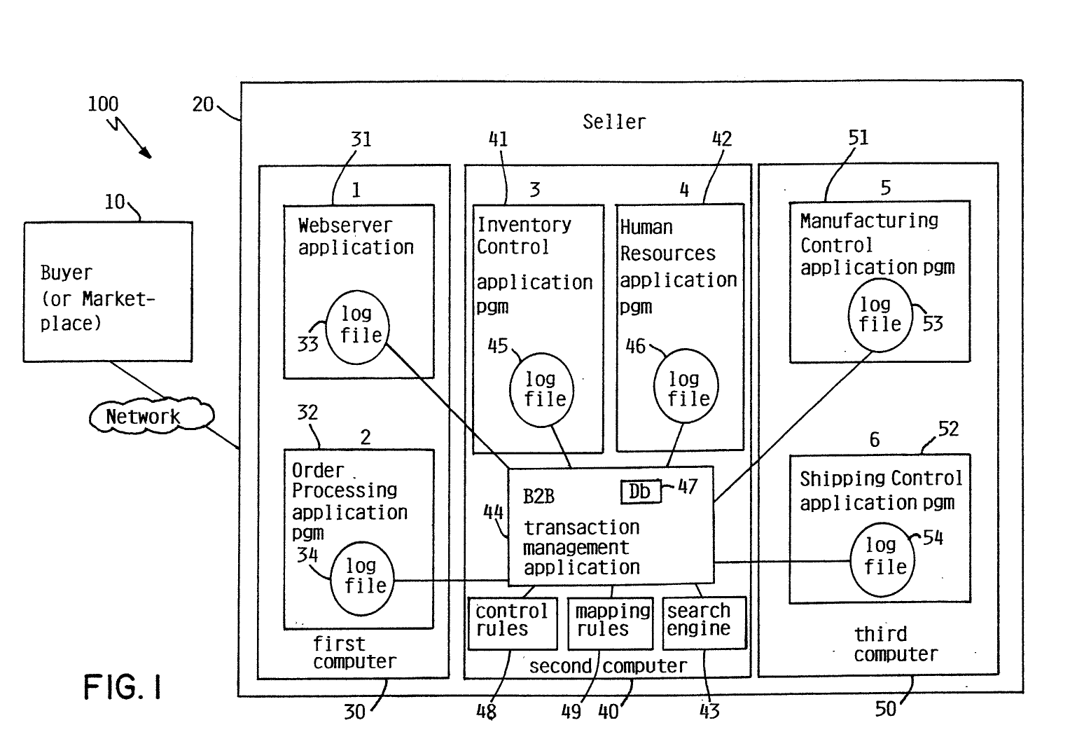

One embodiment of the invention is implemented as a program product for use with a computer system such as, for example, the business transaction environment 100 shown in FIG. 1 and described below. The program(s) of the program product defines functions of the embodiments (including the methods disclosed herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Referring now to FIG. 1, a block diagram illustrative of a business transaction environment 100, e.g., business to business, business to client, or business to government, in accordance with an embodiment of the present invention is shown. The business transaction environment 100 includes a buyer (or marketplace) 10 and a seller 20. The buyer 10 and the seller 20 are connected through a network, e.g., the Internet. Although only one buyer and one seller is illustrated, the business transaction environment 100 is not limited by the number of buyers and sellers. As illustrated, the seller 20 has three computers, i.e., a first computer 30, a second computer 40 and a third computer 50. Although only three computers are illustrated, the buyer 10 and the seller 20 may have any number of computers to process the transactions. The first computer 30 includes a web server application 31 and an order processing application 32. The web server application 31 has a log file 33 and the order processing application 32 has a log file 34. In this embodiment, the web server application is configured to receive the transaction, e.g., an order. The order processing application 32 is configured to process the order. The second computer 40 includes an inventory control application 41, a human resources application 42, a business transaction management application 44, control rules 48, mapping rules 49 and a search engine 43. The inventory control application 41 has a log file 45 and the human resources application 42 has a log file 46. In this embodiment, the inventory control application 41 is configured to take an inventory of the supplies associated with completing the order. The human resources application 42 may be configured to determine whether there is sufficient human resources to assemble the order. The transaction management application 44 has a database 47 for storing information, and will be discussed in detail below. The control rules specify the various conditions that would trigger an action to resolve those various conditions, which will be discussed herein. The mapping rules 49 provide the map of each log file. That is, the mapping rules indicate whether a certain log file contains a certain information, the location of that information and the format of that information. Even though each log file may contain the same type of information, the format or the location of the information in the log file may be different. Therefore, the mapping rules for different log files may vary. The search engine 43 enables one to search the database 47.

The third computer 50 includes a manufacturing control application 51 and a shipping control application 52. The manufacturing control application 51 has a log file 53 and the shipping control application 52 has a log file 54. In one embodiment, the manufacturing control application 51 is configured to control the manufacturing of the order. The shipping control application 52 may be configured to facilitate shipping of the final product to its final destination.

As shown in FIG. 1, the transaction management application 44 is communicably linked to each log file at the seller 20. In one embodiment, the transaction management program 44, in fact, is communicably linked to every log file in the business transaction environment.

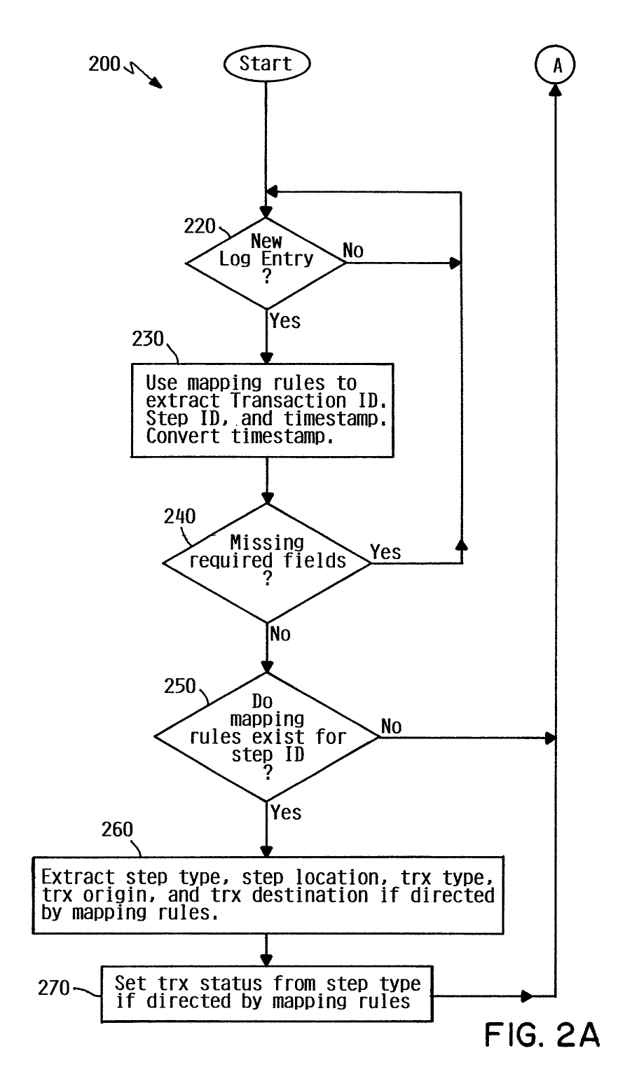

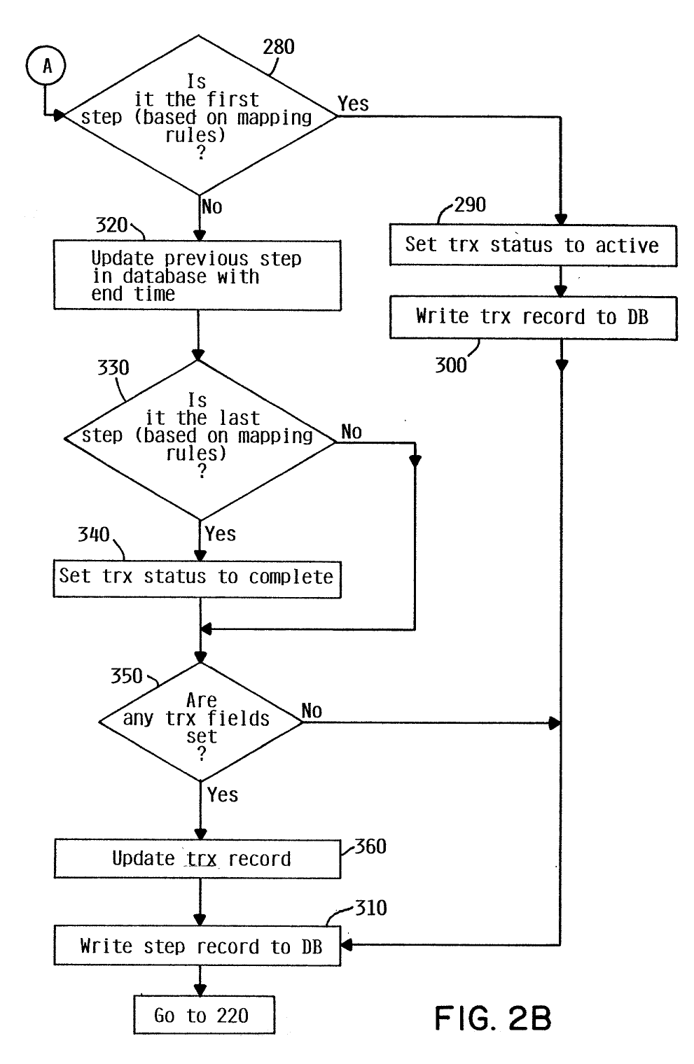

Referring now to FIG. 2, a flowchart illustrative of a process 200 of creating a database, such as, the database 47, for managing a plurality of transactions in a business transaction environment in accordance with an embodiment of the present invention is shown. In one embodiment, the process 200 is implemented by the transaction management program 44. At block 220, a determination is made as to whether a new log entry has been recorded in any log file in the business transaction environment, as shown in block 220. In one embodiment, the logging program (e.g., the web server application 31) that is managing the log file in which the new log entry is recorded sends a notification message to the transaction management program 44 at the time the new log entry is recorded. In another embodiment, the transaction management program 44 polls all the log files in the business transaction environment 100 to determine whether any one of the log files has increased in size. If so, then it is determined that a new log entry has been recorded in that log file. In one embodiment, the polling is performed periodically.

Once the new log entry is detected, the transaction management program 44 begins to extract information from the new log entry according to the mapping rules for that log file, as shown by block 230. A log entry in a business transaction environment typically contains a string of data that keeps track of the history of a transaction as the transaction is processed in a particular application. One log entry from one application may have a different set of information in another application. Generally, however, each log entry has the same type of information, such as, a time stamp (e.g., the time that the entry was recorded), the particular program that recorded the entry, the reason for the entry (e.g., error or audit), a unique identifier associated with the transaction (“transaction ID”), and a unique identifier associated with a step of the transaction (“step ID”). Some log entries may include additional information such as, a transaction type, a transaction origin and a transaction destination. The transaction origin describes the party that originated the transaction, such as, the buyer 10. The transaction destination describes the final destination of the transaction. In one embodiment, the transaction origin and destination for one transaction remain the same. The final destination could be an application at the seller 20 or a third party intended to receive the final by-product of the transaction.

In accordance with an embodiment of the present invention, each transaction in a business transaction environment is broken down to one or more steps. That is, each transaction is defined by one or more steps configured to complete the transaction. Accordingly, some log entries may also include step information, such as, step type and step location. The step type describes the operation performed by an application in completing the transaction. The step location describes the particular computer performing the previously described operation.

As described below, once the information is extracted, the information will be stored in a database, e.g., the database 47, as transaction records and/or step records. Each transaction record will be characterized or identified by fields, i.e., the transaction ID, the transaction origin, the transaction destination, and the transaction status. Each step record will be characterized or identified by fields, i.e., the step ID, the step type, the step location, the step start time and the step end time. In one embodiment, the time stamp is converted to a standard format. In another embodiment, the time stamp is set as the start time of the step, i.e., the step start time.

At block 240, the method 200 determines whether required fields are missing. In one embodiment, the transaction ID, the step ID and the time stamp are required fields. If either the transaction ID, the step ID or the time stamp is missing, then the transaction management program 44 loops back to block 220, as show in block 240. In one embodiment, these data are extracted according to the mapping rules of the log file, which provide information about the location of each information, e.g., the transaction ID, the length of the data string in the new log entry, the format of the information, and the number of steps for each particular transaction.

At block 250, the transaction management program 44 determines whether the mapping rules for the extracted step ID to extract additional fields exist. If the answer is in the affirmative, then one or more of the following information will be extracted: the step type, the step location, the transaction type, the transaction origin, and the transaction destination, as shown in block 260. In one embodiment, if the mapping rules specify that the step type provides a status message, then the information from the step type is stored to the transaction status field in a database, e.g., the database 47, as shown in block 270. For instance, such information from the step type may contain an error message status, indicating that the transaction was not processed properly at the computer on which the error message was logged. Processing then proceeds to block 280 where the transaction management application 44 determines whether the new log entry is the first step of the transaction.

Processing also proceeds to block 280 if block 250 is answered in the negative. In one embodiment, the mapping rules indicate to the transaction management application 44 which step ID correlates with the first step of the transaction. If the answer is in the affirmative, then the transaction status field is set to active, as shown in block 290. The transaction management application 44 then stores the extracted information identifying or characterizing the transaction as a transaction record in the database 47, as shown in block 300. The extracted information identifying the step record is then stored in the database 47 as a step record, as shown in block 310. The process then returns to block 220 in which the transaction management application 44 determines whether a new log entry has been recorded in any log file in the business transaction environment.

Referring back to block 280, if the answer is in the negative, then the time stamp is stored as the step end time of the previous step record in the database 47, as shown in block 320. Then, the transaction management application 44 determines whether the new log entry is the last step of the transaction, as shown in block 330. In one embodiment, the mapping rules indicate to the transaction management application 44 the step ID that correlates with the last step of the transaction. If the answer is in the affirmative, the transaction status field in the database 47 is then set to complete, as shown in block 340. The transaction management application 44 then determines whether the extracted information contains any information identifying a transaction record, e.g., the transaction ID, the transaction origin, the transaction destination, and the transaction status, as shown in block 350. (A negative answer to the query in block 330 will also refer to block 350). If the answer to the query in block 350 is in the affirmative, then that information is stored in the database 47 to update the transaction record, as shown in block 360. The extracted information identifying the step record is then stored in the database 47 as a step record, as shown in block 310. If the answer to the query in block 350 is in the negative, then extracted information identifying the step record is then directly stored in the database 47 as a step record, as shown in block 310. In one embodiment, the answer to the block 350 is negative when the extracted information only contains the transaction ID. The process then returns to block 220 in which the transaction management application 44 determines whether a new log entry has been recorded in any log file in the business transaction environment.

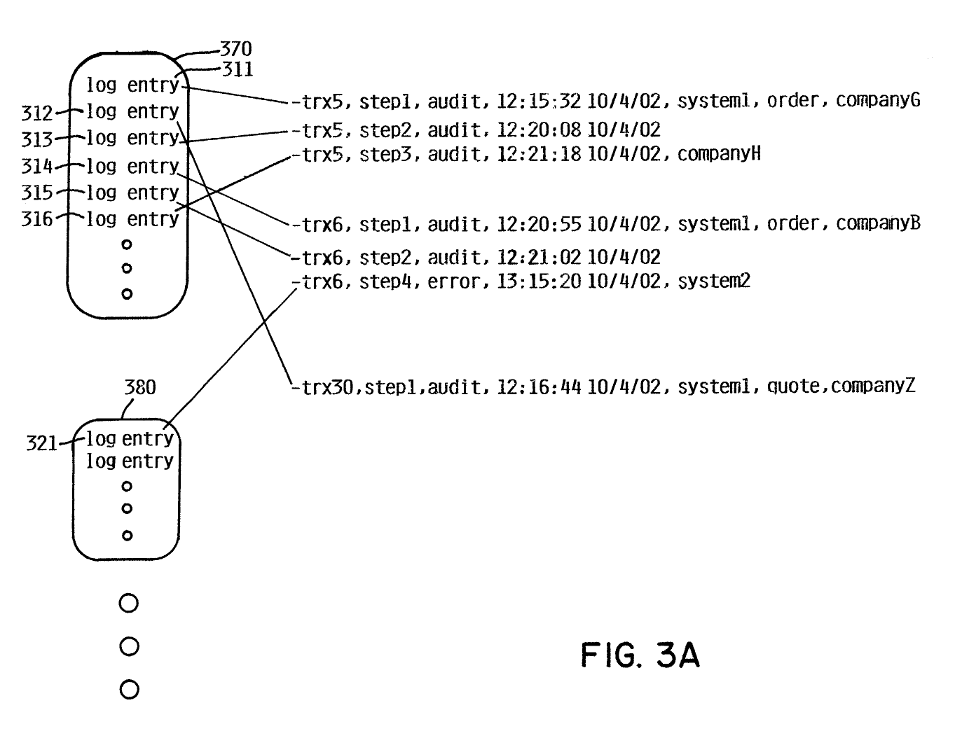

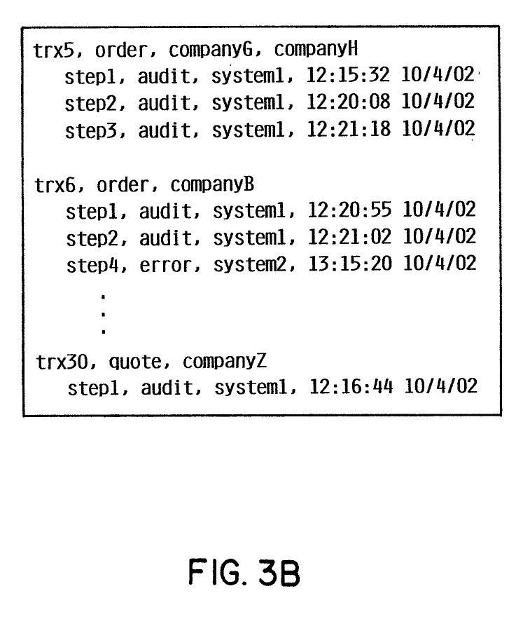

FIGS. 3A illustrates an example of the various information extracted from log files 370 and 380. FIG. 3B illustrates how the extracted information is stored in the database 47 as transaction records and step records. In general, each log file contains a plurality of log entries, each of which contains transaction information and step information. For example, the relevant information extracted from the first log entry 311 comprises: “trx5” as the transaction ID; “step1” as the step ID; “audit” as the step type; “12:15:32 Oct.4, 2002 as the time stamp; “system1” as the step location; “order” as the transaction type; and “companyG” as the transaction origin. In accordance with an embodiment of the present invention, the information identifying the transaction is stored as a transaction record and the information identifying a step of the transaction is stored as a step record, more specifically the first step record that makes up the transaction record. The first log entry, however, does not necessarily have to contain information identifying the first step of a transaction. In one embodiment, the mapping rules specify whether a particular step ID corresponds to the first step of the transaction. For example, the information identifying the second step record for the transaction having the transaction ID “trx5” comes from the third log entry 313, which comprises: “trx5” as the transaction ID; “step2” as the step ID; “audit” as the step type; and “12:20:08 Oct. 4, 2002 as the time stamp. In the third log entry 313, the information for the transaction ID has not changed. Only the information for the step ID and the time stamp have changed. Thus, in accordance with an embodiment of the present invention, only the information for the step ID and the time stamp will be stored in the database 47. That is, the second step record contains the same information as the first step record except for the step ID and the time stamp. In one embodiment, the value in each field remains the same unless changed by the information extracted from a subsequent log entry. The information identifying the third step record for the transaction having the transaction ID “trx5” comes from the sixth log entry 316, which comprises: “trx5” as the transaction ID; “step3” as the step ID; “audit” as the step type; “12:21:18 Oct. 4, 2002 as the time stamp; and “companyH” as the transaction destination. In the sixth log entry 316, only the information for the step ID, the time stamp and the transaction destination have changed. Thus, the third step record contains the same information as the second step record except for the step ID and the time stamp. The transaction record is updated to include the transaction destination. In one embodiment, the mapping rules specifies that “step3” corresponds to the last step in the transaction having the transaction ID of “trx5.” At this step, the transaction status ill be marked complete.

The information identifying the first step record for the transaction having the transaction ID “trx6” comes from the fourth log entry 314 of the log file 370, which comprises: “trx6” as the transaction ID; “step1” as the step ID; “audit” as the step type; “12:20:55 Oct. 4, 2002 as the time stamp; “system1” as the step location; “order” as the transaction type and “companyB” as the transaction origin. The information identifying the second step record for the transaction having the transaction ID “trx6” comes from the fifth log entry 315 of the log file 370, which comprises: “trx6” as the transaction ID; “step2” as the step ID; “audit” as the step type; “12:21:02 Oct. 4, 2002 as the time stamp. The information identifying the fourth step record for the transaction having the transaction ID “trx6” comes from the first log entry 321 of the log file 380, which comprises: “trx6” as the transaction ID; “step4” as the step ID; “error” as the step type; “13:15:20 Oct. 4, 2002 as the time stamp; and “system1” as the step location. The fact that the fourth step record comes from a different log file, i.e., the log file 380, indicates that one transaction may be processed by more than one application. The extracted information for the fourth step record indicates that an error has occurred on the third step, thus generating an error message status in the next step, which is the fourth step. Moreover, the step location has changed from “system1” to “system2.”

The information identifying the first step record for the transaction having the transaction ID “trx30” comes from the second log entry 312 of the log file 370, which comprises: “trx30” as the transaction ID; “step1” as the step ID; “audit” as the step type; “12:16:44 Oct. 4, 2002 as the time stamp; “system1” as the step location; “quote” as the transaction type and “companyZ” as the transaction origin.

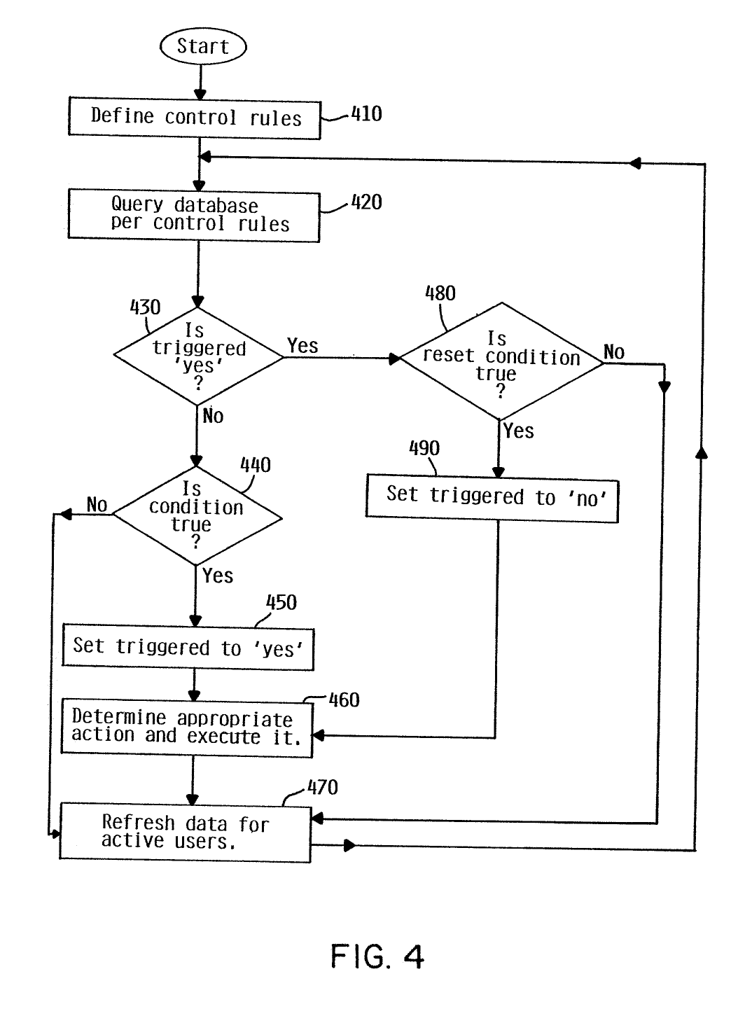

Referring now to FIG. 4, a flowchart illustrative of a process 400 of managing a transaction in a business transaction environment in accordance with an embodiment of the present invention is shown. The first step in the process 400 is to define a set of control rules, as shown in block 410. That is, the control rules are written into the transaction management program 44. The control rules specify the various conditions that would trigger an action to resolve those various conditions, such as, determining the transaction that is taking the longest time to process or determining whether the number of active transactions exceeds a certain numerical limit. In one embodiment, the control rules are based on the fields of the transaction and the step records stored in the database 47. Once the control rules have been defined, the next step (block 420) is to query and select the transaction records in the database 47 that meet a criteria of the condition, as defined by the control rules. For instance, if the condition is the number of active transactions that exceeds a numerical limit, the transaction management application 44 then determines the count of active transactions at block 420. Then, the transaction management application 44 determines whether a trigger field has been set to “yes,” as shown in block 430. The transaction management application 44 then determines whether the condition exists, as shown in block 440. For instance, again, if the condition is the number of active transactions that exceeds a numerical limit, then the transaction management application 44 determines whether the count of active transactions exceeds a numerical limit, as defined by the control rules. If the condition exists, then the trigger field is set to “yes,” as shown in block 450. Then, the transaction management application 44 determines and executes an appropriate action, as shown in block 460. For instance, again, if the condition is the number of active transactions that exceeds a numerical limit, then the transaction management application 44 may be configured to send a notification message indicating the existence of the condition, i.e., that the number of active transactions has exceeded a numerical limit. In another embodiment, the appropriate action is executing a particular application to resolve the condition. The next step is to refresh the data stored in the database, as shown in block 470. Processing also proceeds to 470 from block 440, if the condition does not exist. The process then loops back to block 420.

Referring back to block 430, if the trigger field is set to “yes,” then the next step is to determine whether a reset condition exists, as shown in block 480. For instance, again, if the condition is exceeding a numerical limit of active transactions, then the transaction management application 44 determines whether the count of active transactions exceeds a another numerical limit less than the numerical limit in block 440. If the reset condition exists then the trigger field is set to “no,” as shown in block 490, otherwise the data stored in the database is refreshed, as shown in block 470. The trigger field being set to “no” indicates that the condition still exists. On the other hand, the trigger set being set to “yes” indicates that the condition no longer exists. If the trigger field is set to “no,” then the transaction management application 44 determines an appropriate action and execute the appropriate action, as shown in block 460. For instance, again, if the condition is the number of active transactions that exceeds a numerical limit, then the transaction management application 44 determines the appropriate action, e.g., sending a notification message indicating that the condition no longer exists.

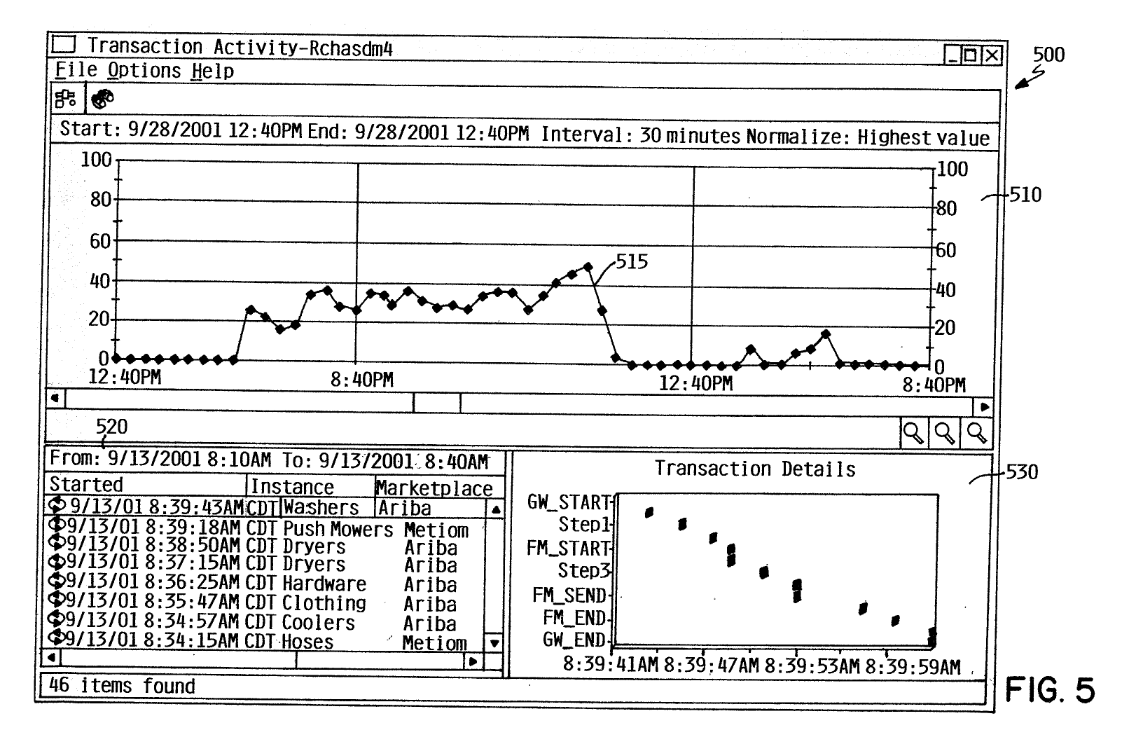

In one embodiment, any information associated with the transaction and step records stored in the database, e.g., database 47, can be displayed graphically or textually. The display can then be used for trend analysis, capacity planning and various performance analysis, including identifying the specific devices that have failed. An embodiment of such display is illustrated in FIG. 5. As shown in FIG. 5, the display 500 has three sections. The top section 510 shows a line graph 515 of the active transaction count over a period of time. The lower left section 520 depicts a list of the transactions that were active at a point in time. The lower right section 530 shows a chart of the steps for a particular transaction. When a user selects a point on the line graph 515, the transactions that were active at that time will be listed in the lower left section 520. If the user then selects one of these transactions, the steps that have been logged for that transaction will be represented in the chart that is displayed in the lower right section 530.

In another embodiment, all the information in the database is searchable by the individual fields of the transaction/step records. This capability for viewing and searching the information stored in the database on a real time basis provides the platform for an easier and better way of transaction analysis.

While the foregoing is directed to embodiments of the present invention, other and further embodiments of the invention may be devised without departing from the basic scope thereof, and the scope thereof is determined by the claims that follow.

What is claimed is:

1. A method of maintaining a database for managing the process of a plurality of transactions through two or more applications in a business transaction environment, each application having at least one associated log file, each transaction being defined by one or more steps configured to complete the transaction, for each new log entry recorded in the at least one associated log file, the method comprising:
determining whether the new log entry comprises one of more required fields;
extracting information from the new log entry only if the new log entry comprises the one of more required fields; and
storing the information as a plurality of transaction records to a database.

2. The method of claim 1, further comprising receiving a notification message from the at least one associated log file indicating that the new log entry has been recorded in the at least one associated log file.

3. The method of claim 1, wherein determining whether the new log entry comprises the one or more required fields comprises determining whether the new log entry comprises the one or more required fields using a set of mapping rules providing the format and the location of the information in the new log entry.

4. The method of claim 1, wherein the information is extracted from the new log entry using a set of mapping rules providing the format and the location of the information in the new log entry.

5. The method of claim 1, further comprising determining whether the plurality of transaction records meets an undesirable condition; and executing an action responsive to the undesirable condition if the plurality of transactions meets the condition.

6. The method of claim 5, wherein the condition is whether a number of the plurality of transaction records indicative of active transactions exceeds a predefined numerical limit.

7. The method of claim 5, wherein the condition is whether any of the plurality of transaction records indicative of active transactions has a time duration exceeding a predefined time limit.

8. The method of claim 5, wherein executing the action comprises sending a notification message alerting the condition.

9. The method of claim 5, wherein the action comprises executing a computer program for resolving the condition.

10. The method of claim 1, wherein the one or more required fields comprises at least one of a transaction identifier, a step identifier, and a time stamp.

11. The method of claim 10, wherein step identifier is a unique identifier associated with a step of the transaction.

12. The method of claim 10, wherein the time stamp indicates a time at which the step started.

13. The method of claim 1, wherein the information comprises at least one of a transaction type, a transaction origin, and a transaction destination; the transaction type, the transaction origin and the transaction destination identifying the transaction record.

14. The method of claim 13, wherein the transaction type describes the type of transaction.

15. The method of claim 13, wherein the transaction origin describes an entity that originated the transaction.

16. The method of claim 13, wherein the transaction destination describes a final destination of the transaction.

17. The method of claim 1, wherein storing the information comprises storing the information to the database as one of a transaction record and a step record, the transaction record being defined by one or more step records.

18. The method of claim 17, wherein the information comprises at least one of a step type and a step location, the step type and the step location identifying the step record.

19. The method of claim 18, wherein the step type describes the operation performed by one of the two or more applications at the time the new log entry is recorded.

20. The method of claim 18, wherein the step location describes a computer of at least one of the two or more applications.

21. A computer-readable medium containing a program which, when executed by a processor, performs an operation of maintaining a database for managing the process of a plurality of transactions through two or more applications in a business transaction environment, each application having at least one associated log file, each transaction being defined by one or more steps configured to complete the transaction, for each new log entry recorded in the at least one associated log file, the operation comprising:
determining whether the new log entry comprises one of more required fields;
extracting information from the new log entry only if the new log entry comprises the one of more required fields; and
storing the information as a plurality of transaction records to the database.

22. The computer-readable medium of claim 21, further comprising:
determining whether the plurality of transaction records meets a condition; and
executing an action if the plurality of transactions meets the condition.

23. The computer-readable medium of claim 21, wherein the one or more required fields comprises at least one of a transaction identifier, a step identifier, and a time stamp.

24. The computer-readable medium of claim 21, wherein creating the database comprising a plurality of transaction records from the information comprises storing the information to the database as one of a transaction record and a step record, the transaction record being defined by one or more step records.

25. The computer-readable medium of claim 21, wherein the information is extracted from the new log entry using the set of mapping rules providing the format and the location of the information in the new log entry.

26. The computer-readable medium of claim 22, wherein the condition is whether a number of the plurality of transaction records indicative of active transactions exceeds a predefined limit.

27. The computer-readable medium of claim 22, wherein the condition is whether any of the plurality of transaction records indicative of active transactions has a time duration exceeding a predefined time limit

28. The computer-readable medium of claim 22, wherein executing the action comprises sending a notification message alerting the condition.

29. A computer, comprising:
a database maintenance program for managing the process of a plurality of transactions through two or more applications in a business transaction environment, each application having at least one associated log file, each transaction being defined by one or more steps configured to complete the transaction; and
for each new log entry recorded in the at least one associated log file, the transaction management program, when executed, performs an operation comprising:
determining whether the new log entry comprises one of more required fields;
extracting information from the new log entry only if the new log entry comprises the one of more required fields; and
storing the information as a plurality of transaction records to the database.

30. The computer of claim 29, further comprising:
determining whether the plurality of transaction records meets a condition; and
executing an action if the plurality of transactions meets the condition.
